(19) United States
(12) Patent Application Publication
(10) Pub. No.: US 2020/0041826 A1
(43) Pub. Date: Feb. 6, 2020

(54) PANEL BAKING APPARATUS

(71) Applicant: Wuhan China Star Optoelectronics Technology Co., Ltd., Wuhan, Hubei (CN)

(72) Inventor: Kaixin LIU, Wuhan, Hubei (CN)

(21) Appl. No.: 15/735,743

(22) PCT Filed: Oct. 31, 2017
(86) PCT No.: PCT/CN2017/108465

§ 371 Date: Dec. 12, 2017

(30) Foreign Application Priority Data
Oct. 25, 2017 (CN) 201711008427.6

(51) Int. Cl. G02F 1/13; H05B 3/26; G02F 1/1337

(52) U.S. Cl. CPC G02F 1/1303; G02F 1/13378; H05B 3/26

(57) ABSTRACT

A panel baking apparatus, including: a heating plate disposed with a plurality of holes thereon, and the holes being are controllably opened or closed; a plurality of supporting bar for supporting a panel to be baked disposed on a side of the heating plate, and the set position of the supporting bar corresponds to the set position of the hole and the supporting bar moves in a direction of an axis of the hole. The holes is controllably opened, the supporting bar moves upward in the direction of the axis of the hole and through the hole, and supports the panel to be baked positioned on the side of the heating plate; the supporting bar moves downward in the direction of the axis of the hole and out of the hole, the hole is controllably closed, and the panel to be baked is supported on the smooth heating plate.

### RELATED APPLICATIONS

The present application is a National Phase of International Application Number PCT/CN2017/108465, filed Oct. 31, 2017, and claims the priority of China Application No. 201711008427.6, filed Oct. 25, 2017.

### FIELD OF THE DISCLOSURE

The disclosure relates to the field of panel manufacturing, and particularly to a panel baking apparatus.

### PRIOR ART

In the prior art, during the process of manufacturing LCD panel, the coated alignment layer is subjected to baking to shape. In order to meet the requirement for taking and placing a panel from and into a baking oven, it is required to design a supporting bar in the baking oven as a tool bearing the panel.

Due to the unreasonable structure design, the prior panel baking apparatuses have the following technical problems.

Uneven heating easily occurs between the position of the supporting bar and a non-supporting region in the baking apparatuses.

Due to the extreme sensitivity of the alignment layer of LTPS products during baking molding, uneven heating easily results in uneven alignment layer, it is easily developed to show poor and influences on the quality of products.

### SUMMARY

A technical problem to be solved by the disclosure is to provide a panel baking apparatus, so as to solve the problem of the heating plate having different heating circumstances in a region of the arranged supporting bar and other regions, avoid uneven heating of the alignment layer during baking and improve the quality and yield of products.

In order to solve the above problem, an embodiment of the disclosure provides a panel baking apparatus, including: a heating plate disposed with a plurality of holes thereon and the holes being controllably opened or closed; a plurality of supporting bar for supporting a panel to be baked disposed on a side of the heating plate, the set position of the supporting bar corresponding to the position of the hole and the supporting bar moving in a direction of an axis of the hole. Wherein the holes is controllably opened, and the supporting bar moves upward in the direction of the axis of the hole and through the hole, and supports the panel to be baked positioned on the side of the heating plate; the supporting bar moves downward in the direction of the axis of the hole and out of the hole, and the hole is controllably closed, and the panel to be baked is supported on the smooth heating plate.

Wherein, the supporting bar ascends or descends vertically in the direction of the axis of the hole.

Wherein, the number of the supporting bars is one-to-one correspondence to the number of the holes.

Wherein, the plurality of supporting bars are disposed equally spaced apart from one another.

Wherein, the holes on the heating plate are disposed equally spaced apart from one another.

Wherein the heating plate includes a X-ray emitting device for static elimination on a side thereof for supporting the panel to be baked.

In order to solve the above problem, an embodiment of the disclosure provides a panel baking apparatus, including: a heating plate disposed with a plurality of holes thereon, and the holes being controllably opened or closed; a plurality of supporting bar for supporting a panel to be baked disposed on a side of the heating plate, the set position of the supporting bar corresponding to the position of the hole and the supporting bar moving in a direction of a axis of the hole. Wherein the holes is controllably opened, and the supporting bar moves upward in the direction of the axis of the hole and through the hole and supports the panel to be baked positioned on the side of the heating plate; the supporting bar moves downward in the direction of the axis of the hole and out of the hole, and the hole is controllably closed, and the panel to be baked is supported on the smooth heating plate; a X-ray emitting device for static elimination is disposed on a side of the heating plate for supporting the panel to be baked; the supporting bar ascends or descends vertically in the direction of the axis of the hole.

Wherein, the number of the supporting bars is one-to-one correspondence to the number of the holes.

Wherein, the plurality of supporting bars are disposed equally spaced apart from one another.

Wherein, the holes on the heating plate are disposed equally spaced apart from one another.

In order to solve the above-mentioned problem, an embodiment of the disclosure provides a panel baking apparatus, including: a heating plate disposed with a plurality of holes thereon, and the holes being controllably opened or closed; a plurality of supporting bar for supporting a panel to be baked, disposed on a side of the heating plate, the set position of the supporting bar corresponds to the position of the hole and the supporting bar moves in a direction of a axis of the hole. Wherein: the holes is controllably opened, and the supporting bar moves upward in the axis of the hole and through the hole, and supports the panel to be baked positioned on the side of the heating plate; the supporting bar moves downward in the direction of the axis of the hole and out of the hole, and the hole is controllably closed, and the panel to be baked is supported on the smooth heating plate; the number of the supporting bars is one-to-one correspondence the number of the holes.

Wherein, the plurality of supporting bars are disposed equally spaced apart from one another.

Wherein, the holes on the heating plate are disposed equally spaced apart from one another.

Wherein, the heating plate includes a X-ray emitting device for static elimination on a side thereof for supporting the panel to be baked.

The panel baking apparatuses provided by the implementation of the disclosure offer the advantageous effects as follows.

First, the holes is controllably opened, and the supporting bar moves upward in the direction of the axis of the hole and through the hole, and supports the panel to be baked positioned on the side of the heating plate; the supporting bar moves downward in the direction of the axis of the hole and out of the hole, and the panel to be baked is supported on heating plate, and the hole is controllably closed, so that all of the panels may be in direct contact with the heating plate during heated, the heating plate provides even heating environment for the panels, so as to solve the problem of heating plate having different heating circumstances in the region of the arranged supporting bars and other regions, avoid uneven heating of the alignment layer during baking and improve the quality of products.

Second, the X-ray emitting device is disposed, it may avoid possible occurrence of electrostatic damage due to a substrate being away from the heating plate and increase the yield of products.

Third, the structure is simplified for convenient repair and maintenance.

### BRIEF DESCRIPTION OF THE DRAWINGS

In order to more clearly illustrate the embodiments of the disclosure or technical solutions in the prior art, a brief introduction to drawings to be used in the embodiments or the prior art description is made. Evidently, the drawings in the description below are merely some embodiments of the disclosure, and a person skilled in the art can obtain other drawings according to these drawings without paying creative labors.

FIG. 1 is a structural schematic view of a panel baking apparatus according to an embodiment of the disclosure.

### DETAILED DESCRIPTION OF PREFERRED EMBODIMENTS

The technical solutions in the embodiments of the disclosure are clearly and completely described below in conjunction with the drawings in the embodiments of the disclosure. Evidently, the embodiments described are merely a part of embodiments of the disclosure, rather than all embodiments. Based on the embodiments of the disclosure, all other embodiments obtained by a person skilled in the art, without paying creative labors, fall into the claimed scope of the disclosure.

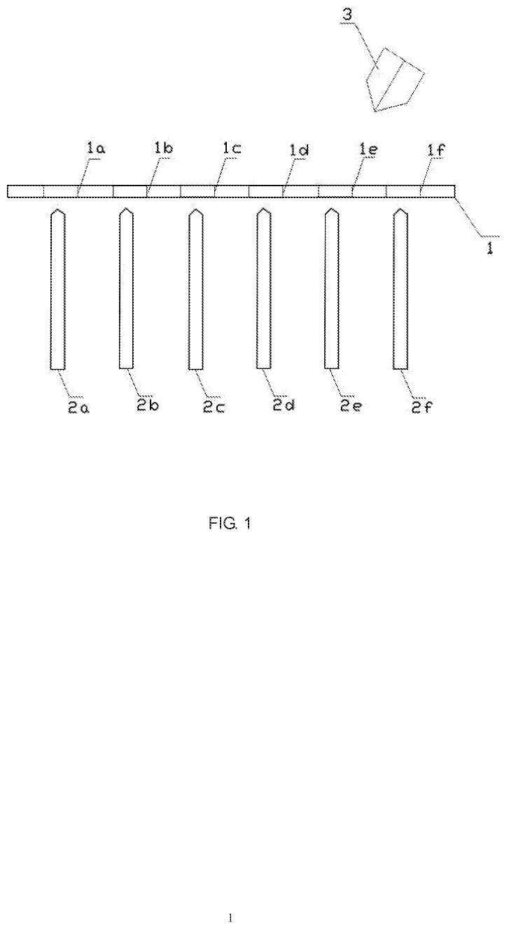

FIG. 1 is an embodiment of the panel baking apparatus according to the disclosure.

The panel baking apparatus in the embodiment includes a heating plate 1, and a plurality of holes 1a, 1b, 1c, 1d, 1e, and 1f are disposed on the heating plate and are controllably opened or closed.

The heating plate 1 is a flat plate capable of heating and is installed in a baking oven. The holes 1a, 1b, 1c, 1d, 1e, and 1f in the embodiment are through-holes. The holes 1a, 1b, 1c, 1d, 1e, and 1f enable the supporting bars to pass through.

Preferably, the holes 1a, 1b, 1c, 1d, 1e, and 1f on the heating plate 1 are disposed equally spaced apart from one another in order to ensure that the supporting bars may hold uniform while passing through the holes and provide a panel to be baked with the uniform support.

The controlled opening and closing of the holes 1a, 1b, 1c, 1d, 1e, and 1f may be achieved by the corresponding controlling device. At the same time, a material for supporting is the same as the material for the heating plate when the holes 1a, 1b, 1c, 1d, 1e, and 1f in a close state so that even heating of the heating plated is meet when heated.

Preferably, the controlled opening of the holes 1a, 1b, 1c, 1d, 1e, and 1f is a synchronous opening and the controlled closing is a synchronous closing so that the probability of operation error may be decreased and process efficiency may also be increased.

It should be understood that the number, position, and size of the holes are not limited in the above embodiments, which may be adjusted based on the actual operational circumstances and would not influence on the effect to be actually attained.

Further, the supporting bars are disposed on a side of the heating plate, at the bottom as shown in FIG. 1. The supporting bars are capable of supporting the panel to be baked. The number of the supporting bars is six in the embodiment, and the six supporting bars are 2a, 2b, 2c, 2d, 2e, and 2f, respectively. In the embodiment, the number of the supporting bars is one-to-one correspondence to the number of the holes. Namely, a plurality of supporting bars 2a, 2b, 2c, 2d, 2e, and 2f are also disposed equally spaced apart from one another. For example, the set position of the supporting bar 2a corresponds to the position of the hole 1a, and the set position of the supporting bar 2b corresponds to the position of the hole 1b, and so on. Such arrangement may increase the supporting density of the supporting bars to the utmost extent.

The supporting bars 2a, 2b, 2c, 2d, 2e, and 2f in the embodiment are round bar or square bar and have the same structure. Taking the supporting bar 2a as an example, the process of its ascending or descending is described below.

The set position of the supporting bar 2a corresponds to the position of the hole 1a and the supporting bar 2a may move in the direction of an axis of the hole 1a. It should be understood that all of the supporting bars are in an operational mode of synchronous ascending or descending so that the accuracy and synchronism of the supporting operation may be guaranteed.

The movement of the supporting bar 2a in the direction of the axis of the holes 1a in the embodiment is a vertically upward movement or a vertically downward movement. When specifically implementing, all of the supporting bars 2a, 2b, 2c, 2d, 2e, and 2f ascend to pass through the corresponding holes and may push up the glass panel at the top side of the heating plate 1 as shown in FIG. 1, thereby facilitating mechanical hands to operate the glass panel in the baking oven. While it is required to bake the panel, all of the supporting bars 2a, 2b, 2c, 2d, 2e, and 2f descend and the holes 1a, 1b, 1c, 1d, 1e, and 1f are controllably closed, and the panel directly falls down to the smooth heating plate 1, such that the heating plate 1 bakes the panel evenly.

When specifically carrying out the panel baking apparatus in the embodiment, the holes 1a, 1b, 1c, 1d, 1e, and 1f are controllably synchronously opened, and the supporting bars 2a, 2b, 2c, 2d, 2e, and 2f move upward synchronously and through the holes in the direction of the axis of the corresponding hole, respectively. The supporting bars push up the panel to be baked positioned at the side of the heating plate 1 after passing through the holes, thereby facilitating mechanical hands to operate the glass panel in the baking oven. While it is required to bake the panel, all of the supporting bars 2a, 2b, 2c, 2d, 2e, and 2f move downward synchronously and out of the holes in the direction of the axis of the corresponding hole, respectively, and the holes are controllably closed, and the panel to be baked is directly supported by the smooth heating plate.

In other embodiments of the panel baking apparatus according to the disclosure, the panel baking apparatus also includes a X-ray emitting device 3, and the X-ray emitting device 3 is disposed on a side of the heating plate 1.

The X-ray emitting device 3 has the function of eliminating static electricity and may avoid possible occurrence of electrostatic damage due to a substrate being away from the smooth heating plate 1.

The panel baking apparatuses provided by the implementation of the disclosure offer the advantageous effects as follows.

First, the holes is controllably opened, and the supporting bar moves upward in the direction of the axis of the hole and through the hole, and supports the panel to be baked positioned on the side of the heating plate; the supporting bar moves downward in the direction of the axis of the hole and out of the hole, and the panel to be baked is supported on heating plate, and the hole is controllably closed, so that all of the panels may be in direct contact with the heating plate during heated, the heating plate provides even heating environment for the panels, so as to solve the problem of the heating plate having different heating circumstances in the region of the arranged supporting bars and other regions, avoid uneven heating of the alignment layer during baking and improve the quality of products.

Second, the X-ray emitting device is disposed, it may avoid possible occurrence of electrostatic damage due to a substrate being away from the heating plate and increase the yield of products.

Third, the structure is simplified for convenient repair and maintenance.

What is claimed is:

1. A panel baking apparatus, comprising:
a heating plate, disposed with a plurality of holes thereon, and the holes being controllably opened or closed; and
a plurality of supporting bar for supporting a panel to be baked, disposed on a side of the heating plate, the set position of the supporting bar corresponding to the position of the hole and the supporting bar moving in a direction of an axis of the hole, wherein:
the holes is controllably opened, and the supporting bar moves upward in the direction of the axis of the hole and through the hole, and supports the panel to be baked positioned on the side of the heating plate; the supporting bar moves downward in the direction of the axis of the hole and out of the hole, and the hole is controllably closed, and the panel to be baked is supported on the smooth heating plate.

2. The panel baking apparatus according to claim 1, wherein the supporting bar ascends or descends vertically in the direction of the axis of the hole.

3. The panel baking apparatus according to claim 2, wherein the number of the supporting bars is one-to-one correspondence to the number of the holes.

4. The panel baking apparatus according to claim 3, wherein the plurality of supporting bars are disposed equally spaced apart from one another.

5. The panel baking apparatus according to claim 3, wherein the holes on the heating plate are disposed equally spaced apart from one another.

6. The panel baking apparatus according to claim 1, wherein the heating plate comprises a X-ray emitting device for static elimination on a side thereof for supporting the panel to be baked.

7. A panel baking apparatus, comprising:
a heating plate, disposed with a plurality of holes thereon, and the holes being controllably opened or closed; and
a plurality of supporting bar for supporting a panel to be baked, disposed on a side of the heating plate, the set position of the supporting bar corresponding to the position of the hole and the supporting bar moving in a direction of a axis of the hole, wherein:
the holes is controllably opened, and the supporting bar moves upward in the direction of the axis of the hole and through the hole and supports the panel to be baked positioned on the side of the heating plate; the supporting bar moves downward in the direction of the axis of the hole and out of the hole, and the hole is controllably closed, and the panel to be baked is supported on the smooth heating plate;
a X-ray emitting device for static elimination is disposed on a side of the heating plate for supporting the panel to be baked;
the supporting bar ascends or descends vertically in the direction of the axis of the hole.

8. The panel baking apparatus according to claim 7, wherein the number of the supporting bars is one-to-one correspondence to the number of the holes.

9. The panel baking apparatus according to claim 8, wherein the plurality of supporting bars are disposed equally spaced apart from one another.

10. The panel baking apparatus according to claim 8, wherein the holes on the heating plate are disposed equally spaced apart from one another.

11. A panel baking apparatus, comprising:
a heating plate, disposed with a plurality of holes thereon, and the holes being controllably opened or closed; and
a plurality of supporting bar for supporting a panel to be baked, disposed on a side of the heating plate, the set position of the supporting bar corresponding to the position of the hole and the supporting bar moving in a direction of a axis of the hole, wherein:
the holes is controllably opened, and the supporting bar moves upward in the axis of the hole and through the hole, and supports the panel to be baked positioned on the side of the heating plate; the supporting bar moves downward in the direction of the axis of the hole and out of the hole, and the hole is controllably closed, and the panel to be baked is supported on the smooth heating plate;
the number of the supporting bars is one-to-one correspondence to the number of the holes.

12. The panel baking apparatus according to claim 11, wherein the plurality of supporting bars are disposed equally spaced apart from one another.

13. The panel baking apparatus according to claim 11, wherein the holes on the heating plate are disposed equally spaced apart from one another.

14. The panel baking apparatus according to claim 11, wherein the heating plate comprises a X-ray emitting device for static elimination on a side thereof for supporting the panel to be baked.
